(19) United States
(12) Patent Application Publication
(10) Pub. No.: US 2014/0107958 A1
(43) Pub. Date: Apr. 17, 2014

(54) CALIBRATION APPARATUS, CALIBRATION METHOD, AND MEASUREMENT APPARATUS

(71) Applicant: CANON KABUSHIKI KAISHA, Tokyo (JP)

(72) Inventor: Naoto Hayashi, Haga-gun (JP)

(73) Assignee: CANON KABUSHIKI KAISHA, Tokyo (JP)

(21) Appl. No.: 14/044,554

(22) Filed: Oct. 2, 2013

(30) Foreign Application Priority Data
Oct. 16, 2012 (JP) 2012-229243
Sep. 13, 2013 (JP) 2013-191036

(51) Int. Cl. G01B 21/04

(52) U.S. Cl. CPC G01B 21/042
USPC 702/95; 702/94

(57) ABSTRACT

The present invention provides a calibration apparatus for calibrating an optical apparatus, which has a scanning member and scans light on an object by rotating the scanning member, including a target member including a region irradiated with light from the scanning member, an obtaining unit configured to obtain a light amount of light reflected by the region, and a processing unit configured to execute processing for calculating a calibration value required to calibrate a rotation angle of the scanning member, wherein the region is configured to be nonplanar so that a light amount obtained by the obtaining unit changes according to a light irradiation position.

### BACKGROUND OF THE INVENTION

1. Field of the Invention

The present invention relates to a calibration apparatus, calibration method, and measurement apparatus.

2. Description of the Related Art

In recent years, as an apparatus for measuring a shape of an object, a scanning type shape measurement apparatus (to be referred to as “measurement apparatus” hereinafter), which scans a probe (measurement head) on a measurement surface has been studied. Such measurement apparatus calculates a distance between the measurement head and object by irradiating (projecting) the object with light from the measurement head, and detecting light reflected by the object, and calculates a shape of the object based on that distance. The measurement head normally includes an irradiation unit which includes a galvanometer mirror, polygon mirror, and the like required to two-dimensionally scan light with which the object is irradiated, and a detection unit which detects light reflected by the object.

A scanning angle of light on the object can be calculated by detecting a rotation angle of the galvanometer mirror or polygon mirror. However, due to layout deviations of optical elements included in the irradiation unit, a position to be irradiated with light by the irradiation unit (ideal irradiation position) may often have a deviation from a position actually irradiated with light by the irradiation unit (actual irradiation position). Therefore, in order to precisely measure the shape of the object, the actual irradiation position has to be detected (confirmed), and the irradiation unit has to be calibrated so that the actual irradiation position matches the ideal irradiation position. A technique related to such calibration has been proposed by Japanese Patent Laid-Open No. 2004-245672.

The technique proposed by Japanese Patent Laid-Open No. 2004-245672, more specifically, a calibration apparatus 1000 using plane mirrors laid out in a one-dimensional pattern will be described below with reference to FIG. 13. The calibration apparatus 100 includes a stage 1020 on which a measurement head 1010 is placed, a rotation unit 1030 which rotates the stage 1020, and targets 1040. The targets 1040 are configured by plane mirrors, and are arranged in a one-dimensional pattern (for example, along an x axis), as shown in FIG. 13. The rotation unit 1030 has a function of matching a position (irradiation position) of light irradiated from an irradiation unit of the measurement head 1010 with a layout direction of the targets 1040.

Each of the targets 1040 is sequentially irradiated with light by the irradiation unit of the measurement head 1010 while rotating the stage 1020 which places the measurement head 1010 using the rotation unit 1030, and light reflected by each target 1040 is detected by the detection unit of the measurement head 1010. Then, actual data related to light detected by the detection unit of the measurement head 1010 is compared with reference data related to light reflected by the target 1040 when an ideal irradiation position is irradiated with light, and a scanning angle (a deviation thereof) is calculated based on a deviation between the actual irradiation position and ideal irradiation position.

However, with the technique of Japanese Patent Laid-Open No. 2004-245672, since the plane mirror is used as the target, a change in light (actual data) detected by the detection unit with respect to a change in scanning angle is small, and it is difficult to precisely detect the scanning angle (a deviation thereof).

For example, assume that a distance from the measurement head (irradiation unit) to each target is 150 mm, and a diameter of light on an object is 30 μm. Also, assume that a “state in which light perpendicularly enters a target, and a light amount of light detected by the detection unit becomes a maximum light amount” is a first state, and a “state in which light obliquely enters a target, and a light amount of light detected by the detection unit becomes ½ of the maximum light amount” is a second state. In this case, in order to change the first state to the second stage, even when an aperture having a diameter of 3 μm is laid out immediately before the detection unit of the measurement head, a scanning angle has to be changed by 22 μrad. In other words, even when the position of light emitted by the irradiation unit of the measurement head changes by about 6.4 μm, a light amount of light detected by the detection unit changes by only ½ (that is, sensitivity is low). For this reason, the scanning angle (a deviation thereof) cannot be precisely detected.

### SUMMARY OF THE INVENTION

The present invention provides a technique advantageous to precisely calibrate an optical apparatus having a scanning member.

According to one aspect of the present invention, there is provided a calibration apparatus for calibrating an optical apparatus, which has a scanning member and scans light on an object by rotating the scanning member, including a target member including a region irradiated with light from the scanning member, an obtaining unit configured to obtain a light amount of light reflected by the region, and a processing unit configured to execute processing for calculating a calibration value required to calibrate a rotation angle of the scanning member, wherein the region is configured to be nonplanar so that a light amount obtained by the obtaining unit changes according to a light irradiation position, and the processing unit executes a first process for obtaining a light amount of light reflected by the region by the obtaining unit in a state in which the scanning member is rotated so as to irradiate a reference position of the region with light, a second process for calculating an actual irradiation position where the region is actually irradiated with light in the first process based on the light amount obtained in the first process, and a third process for calculating the calibration value from the actual irradiation position calculated in the second process and the reference position of the region.

Further aspects of the present invention will become apparent from the following description of exemplary embodiments with reference to the attached drawings.

### BRIEF DESCRIPTION OF THE DRAWINGS

FIG. 1 is a schematic view showing the arrangement of a measurement apparatus having a calibration apparatus according to one aspect of the present invention.

FIG. 2 is a view showing an example of the practical arrangement of a measurement head of the measurement apparatus shown in FIG. 1.

FIGS. 3A and 3B are views for explaining the principle of calibration of a rotation angle of a galvanometer mirror using a target member in the measurement apparatus shown in FIG. 1.

FIG. 4 is a view showing a section of a mirror element when light comes from a position immediately above the center of curvature of the mirror element of the target member in the measurement apparatus shown in FIG. 1.

FIG. 5 is a graph showing the relationship between a deviation amount of light in an x direction, and a light amount detected by a detector.

FIG. 6 is a view for practically explaining calibration of the galvanometer mirror using the target member in the measurement apparatus shown in FIG. 1.

FIG. 7 is a graph showing an example of a light amount of light reflected by an X alignment mark formed on the target member in the measurement apparatus shown in FIG. 1.

FIG. 8 is a graph showing an example of a light amount of light which is reflected by a cylindrical mirror and is detected by the detector of the measurement head in the measurement apparatus shown in FIG. 1.

FIG. 9 is a schematic view showing the arrangement of a measurement apparatus having a calibration apparatus according to one aspect of the present invention.

FIG. 10 is a view showing an example of the arrangement of the target member in the measurement apparatus shown in FIG. 1.

FIG. 11 is a view showing a mirror having a conical shape of a convex surface formed on the target member in the measurement apparatus shown in FIG. 1.

FIG. 12 is a view for practically explaining calibration of the galvanometer mirror using the target member in the measurement apparatus shown in FIG. 1.

FIG. 13 is a schematic view showing the arrangement of a calibration apparatus using plane mirrors laid out in a one-dimensional pattern.

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

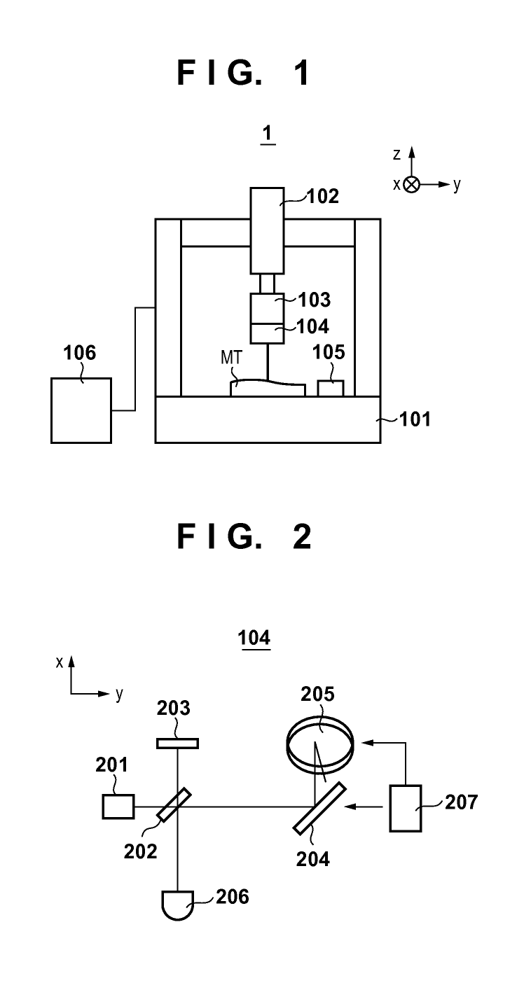

FIG. 1 is a schematic view showing the arrangement of a measurement apparatus 1 having a calibration apparatus according to one aspect of the present invention. The measurement apparatus 1 is a three-dimensional shape measurement apparatus which measures a shape of an object MT using a measurement head 104 including a galvanometer mirror (scanning member). The calibration apparatus is a calibration apparatus used to calibrate a rotation angle (a deviation thereof) of the galvanometer mirror of the measurement head 104 of the measurement apparatus 1. However, the calibration apparatus is also applicable to calibration of an optical apparatus which has a galvanometer mirror and scans light on an object upon rotation of that galvanometer mirror (for example, a laser processing apparatus and the like).

The measurement apparatus 1 includes a surface plate 101, an XYZ stage 102, a rotation stage 103, the measurement head 104, a target member 105, and a processing unit 106. Note that the target member 105 is not a member used upon measurement of the shape of the object MT, but is a member used upon calibration of the measurement apparatus 1. The processing unit 106 includes a CPU, memory, and the like, and controls the entire (operation of) measurement apparatus 1. For example, the processing unit 106 executes not only processing for measuring the shape of the object MT (that is, it functions as a calculation unit for calculating the shape of the object MT based on light reflected by the object MT) but also processing for calculating a calibration value required to calibrate a rotation angle of the galvanometer mirror. In this manner, the target member 105 and processing unit 106 configure a part of the calibration apparatus in this embodiment.

The XYZ stage 102 is set on the surface plate 101. On the XYZ stage 102, the rotation stage 103 and measurement head 104 are set. The measurement head 104 irradiates (projects) the object MT with light, and detects light reflected or scattered by the object MT, thus measuring a distance between the measurement head 104 and object MT.

An example of the practical arrangement of the measurement head 104 will be described below with reference to FIG. 2. The measurement head 104 includes a fiber port 201, half mirror 202, reference mirror 203, galvanometer mirrors 204 and 205, detector 206, and scanning unit 207. The fiber port 201, half mirror 202, reference mirror 203, and galvanometer mirrors 204 and 205 function as an irradiation unit which irradiates the object MT with light. The detector 206 functions as a detection unit which detects light reflected or scattered by the object MT. The scanning unit 207 scans light on the object MT or target member 105 while rotating the galvanometer mirrors 204 and 205.

Light coming from a light source is guided to the measurement head 104 via a fiber or the like, and exists from the fiber port 201. Light from the fiber port 201 enters the half mirror 202, and is split into light reflected by the half mirror 202 and light transmitted through the half mirror 202. The light reflected by the half mirror 202 is reflected by the reference mirror 203, and enters the half mirror 202 again as reference light. On the other hand, the light transmitted through the half mirror 202 is reflected by the galvanometer mirrors 204 and 205, and is projected onto the object MT. Light reflected or scattered by the (surface of the) object MT enters the half mirror 202 again as detected light.

The galvanometer mirror 204 has a rotation axis along a z axis, and the galvanometer mirror 205 has a rotation axis along a y axis. Therefore, when the galvanometer mirror 204 is rotated, light is scanned on the object MT in a y-axis direction, and when the galvanometer mirror 205 is rotated, light is scanned on the object MT in an x-axis direction. In this manner, since the measurement head 104 includes the two galvanometer mirrors 204 and 205, it can irradiate the object MT with light while scanning the light two-dimensionally.

The reference light and detected light which have entered the half mirror 202 form interference light. The detector 206 detects the interference light formed by the reference light and detected light, and outputs an interference signal. The processing unit 106 calculates a difference (optical path length difference) between a reference light optical path length and detected light optical path length based on the interference signal output from the detector 206. The optical path length difference can be calculated using a method of calculating a relative distance from a certain reference, a method of calculating an absolute distance from measurement using light beams of a plurality of wavelengths, or the like. The processing unit 106 calculates a position (x, y, z) of an arbitrary point (actual irradiation position) of the object MT based on a position (coordinates) of the XYZ stage 102, a rotation angle of the rotation stage 103, rotation angles of the galvanometer mirrors 204 and 205, and the detected light optical path length (optical path length difference).

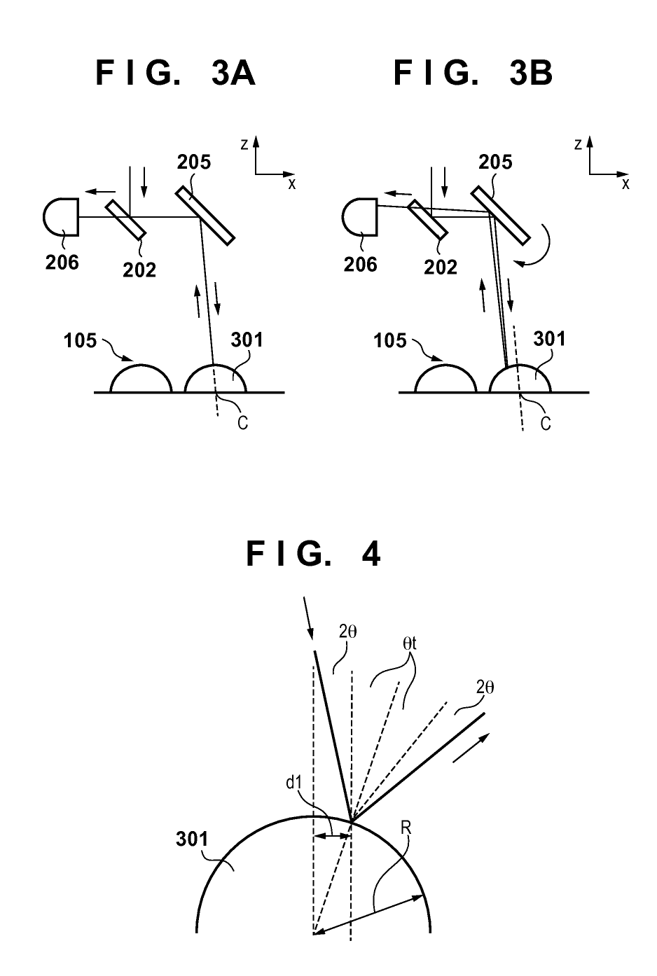

The principle of calibration of the rotation angles of the galvanometer mirrors 204 and 205 using the target member 105 will be described below with reference to FIGS. 3A and 3B. FIGS. 3A and 3B show only a detected light optical path in the measurement head 104, and only the galvanometer mirror 205 of the two galvanometer mirrors 204 and 205.

The target member 105 includes a region irradiated with light reflected by the galvanometer mirrors 204 and 205, and this region is nonplanar. More specifically, this region is configured by a mirror element (reflection member) 301 having a curvature of a convex surface, and is laid out in a two-dimensional pattern in FIGS. 3A and 3B. However, the mirror element 301 may be configured to, for example, change a light amount detected by the detector 206 depending on a light irradiation position, and may have a curvature of a concave surface. Also, in this embodiment, a light amount of light reflected by the mirror element 301 is detected by the detector 206. Alternatively, a detection unit which detects a light amount of light reflected by the mirror element 301 may be arranged independently of the detector 206. In this manner, the detector 206 functions as an obtaining unit which obtains a light amount of light reflected by the mirror element 301, and configures a part of the calibration apparatus in this embodiment.

FIGS. 3A and 3B show a state in which one of a plurality of mirror elements 301 of the target member 105 is irradiated with light. Light reflected by the galvanometer mirror 205 is reflected by the (surface of the) mirror element 301, is transmitted through the half mirror 202, and enters the detector 206. A light amount of light reflected by the mirror element 301 may be calculated from a contrast of interference light detected by the detector 206, or only light reflected by the mirror element 301 may be detected by the detector 206 while shielding light coming from the reference mirror 203. The mirror element 301 is positioned to the galvanometer mirror (scanning member) 205 in a predetermined position in advance.

A case will be examined first wherein a center (center of curvature) C of the mirror element 301 is located on an extension of light reflected by the galvanometer mirror 205, as shown in FIG. 3A. In this case, light reflected by the galvanometer mirror 205 is perpendicularly reflected by the (surface of the) mirror element 301, and enters a central portion of a detection surface of the detector 206. Also, a case will be examined below wherein the center C of the mirror element 301 is not located on the extension of light reflected by the galvanometer mirror 205, as shown in FIG. 3B. In this case, since the extension of light reflected by the galvanometer mirror 205 deviates from the center C of the mirror element 301, light reflected by the galvanometer mirror 205 is not perpendicularly reflected by the mirror element 301, and enters a position deviated from the central portion of the detection surface of the detector 206. In this manner, when the mirror element 301 and detector 206 do not have an optically conjugate relationship, a light amount detected by the detector 206 changes due to a change in rotation angle of the galvanometer mirror 205. Therefore, the rotation angle of the galvanometer mirror 205 can be calculated based on the light amount detected by the detector 206.

The relationship between the rotation angle of the galvanometer mirror 205 and the light amount (light amount value) of light, which is reflected by the mirror element 301 and is detected by the detector 206, will be described below. In this embodiment, since light coming from a light source is guided to the measurement head 104 via a fiber or the like, it forms an Airy pattern on the detection surface of the detector 206. Let d be a deviation amount between the center of the detection surface of the detector 206 and that of the Airy pattern due to rotation of the galvanometer mirror 205 (that is, a deviation amount between the center of the detection surface of the detector 206 and an incident position of light reflected by the mirror element 301 on the detection surface). Also, let a be a radius of an integration region of the Airy pattern detected on the detection surface of the detector 206 (that is, a radius of light which is reflected by the mirror element 301 and enters the detection surface of the detector 206), and (x, y) be position coordinates on the detection surface of the detector 206. In this case, the relationship between the deviation amount d between the center of the detection surface of the detector 206 and that of the Airy pattern and a light amount I_{Airy} detected by the detector 206 is expressed by:

$${I}_{Airy} ( d , a ) = {\int }_{- a}^{a} {\int }_{- a}^{a} {( \frac{2 {J}_{1} ( \sqrt{{x}^{2} + {( y - d )}^{2}} )}{\sqrt{{x}^{2} + {( y - d )}^{2}}} )}^{2} d x d y \qquad ( 1 )$$

where J₁( ) expresses a Bessel function of the first kind, which assumes that light entering the detection surface of the detector 206 is deviated in the y direction. Also, the deviation amount d and the radius a of the integration region in equation (1) can be expressed by variables of an actual system. Note that the variables of the actual system include a radius of curvature R of the mirror element 301, a radius (beam spot radius) BS of light entering the target member 105, and a radius Rd of the detection surface of the detector 206. Furthermore, the variables of the actual system also include a distance WD1 from the galvanometer mirror 205 to the target member 105, and a distance WD2 from the detector 206 to the target member 105.

The variables (R, BS, Rd, WD1, and WD2) of the actual system will be described below with reference to FIG. 4. FIG. 4 shows a section of the mirror element 301 when light comes from a position immediately above the center of curvature of the mirror element 301.

The relationship between the deviation amount d and the variables (R, BS, Rd, WD1, and WD2) of the actual system will be described first. A deviation amount d1 of light incident on the target member 105 (mirror element 301) caused by a rotation angle θ of the galvanometer mirror 205 is expressed using the distance WD1 from the galvanometer mirror 205 to the target member 105 by:

d1=2θWD1 (2)

When the radius of curvature R of the mirror element 301 is used, a reflection angle θₜ of light perpendicularly entering a position shifted by d1 from the perpendicularly reflected position with respect to the mirror element 301 is expressed by:

$${θ}_{t} = arctan ( \frac{d 1}{\sqrt{{R}^{2} - d {1}^{2}}} ) \approx \frac{d 1}{R} ( d 1 ≪ 1 ) \qquad ( 3 )$$

A reflection angle θr of light reflected by the mirror element 301 with respect to the rotation angle θ of the galvanometer mirror 205 is given by θr=2(2θ+θₜ). Therefore, a deviation amount d2 of light reflected by the mirror element 301 is expressed using the distance WD2 from the detector 206 to the target member 105 by:

d2=(2θ+2θₜ)WD2≈2θₜWD2(θ<<θₜ) (4)

Therefore, the deviation amount d between the center of the detection surface of the detector 206 and that of the Airy pattern with respect to the rotation angle θ of the galvanometer mirror 205 is expressed by:

$$d ( θ , R , WD 1 , WD 2 ) = d 1 + d 2 \approx \frac{4 θ WD 1 WD 2}{R} ( θ ≪ {θ}_{t} ) \qquad ( 5 )$$

Next, the radius a of the integration region and the variables (R, BS, Rd, WD1, and WD2) of the actual system will be described below. Assume that light entering the target member 105 is parallel light having sufficiently small NA. Using the radius Rd of the detection surface of the detector 206, a radius d_{A} of light detected by the detector 206 on the target member 105 is expressed by:

$$Rd = 2 WD 2 \cdot \frac{{d}_{A}}{R} -> {d}_{A} = \frac{RdR}{2 WD 2} \qquad ( 6 )$$

This radius d_{A} can be calculated from the relationship in which light reflected by the reflection angle θt given by equation (3) matches the radius Rd of the detection surface of the detector 206.

Therefore, by substituting the radius (the first dark ring of the Airy pattern) BS of light entering the target member 105 into equation (6), the radius a of the integration region is expressed by:

$$a ( R , Rd , WD 2 , BS ) = \frac{3.83 {d}_{A}}{BS \sqrt{{x}^{2} + {y}^{2}}} = \frac{1.9156 Rd \cdot R}{WD 2 \cdot BS \sqrt{{x}^{2} + {y}^{2}}} \qquad ( 7 )$$

Note that the radius a of the integration region may be adjusted by laying out an aperture in front of (incident surface side) of the detection surface of the detector 206 to select only required light.

By substituting equations (5) and (7) into equation (1), an ideal value of a light amount detected by the detector 206, that is, an ideal light amount I_{Airy} with resect to the rotation angle θ of the galvanometer mirror 205 can be calculated.

Assuming that a rotation angle of the galvanometer mirror 205 when a light amount detected by the detector 206 is a maximum light amount is 0, a ratio e between the maximum light amount and a light amount detected by the detector 206 when the rotation angle of the galvanometer mirror 205 is θ1 is expressed by:

$$ɛ = \frac{{I}_{Airy} ( d ( θ 1 , R , WD 1 , WD 2 ) , a ( WD 2 , BS ) )}{{I}_{Airy} ( d ( 0 , R , WD 1 , WD 2 ) , a ( WD 2 , BS ) )} \qquad ( 8 )$$

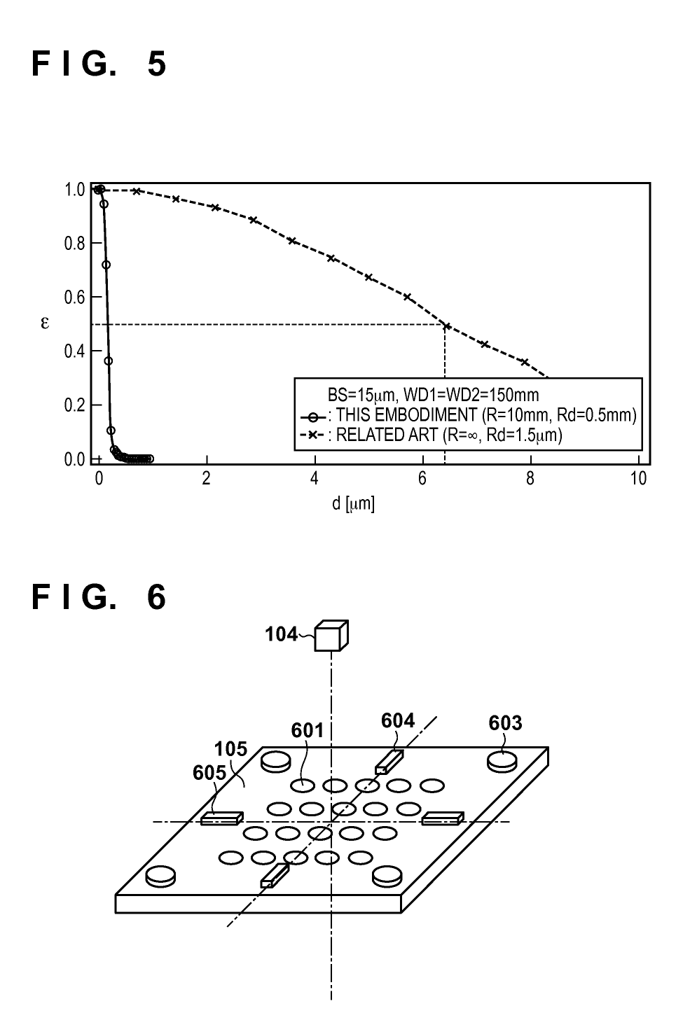

For example, if the variables of the actual system are set to be R=10 mm, BS=15 μm, Rd=0.5 mm, WD1=150 mm, and WD2=150 mm, the relationship between the deviation amount d in the x direction and the light amount I_{Airy} is indicated by a solid curve in FIG. 5 from equation (1). FIG. 5 also shows the relationship between the deviation amount in the x direction and ideal light amount I_{Airy} in the related art (that is, when the target member is a plane mirror (R=∞ and Rd=0.003 mm) by a dotted curve. Furthermore, FIG. 5 plots the ratio ε on the abscissa, and the deviation amount d in the x direction on the ordinate.

Referring to FIG. 5, in this embodiment, the deviation amount d when the light amount detected by the detector 206 is halved (ε=0.5) is 0.2 μm, and the rotation angle θ of the galvanometer mirror 205 is 0.67 μrad. On the other hand, in the related art, the deviation amount d when the light amount detected by the detector 206 is halved is 6.4 μm, and the rotation angle θ of the galvanometer mirror 205 is 22 μrad. As can be seen from the above description, in this embodiment, a change in light amount detected by the detector 206 with respect to the position deviation of light projected onto the target member 105 is increased to about 30 times compared to the related art. Therefore, in this embodiment, since the rotation angle of the galvanometer mirror 205 can be precisely detected, the rotation angle (a deviation thereof) of the galvanometer mirror can be precisely calibrated.

The aforementioned principle of calibration of the rotation angle of the galvanometer mirror, that is, calibration of the galvanometer mirrors 204 and 205 using the target member 105 will be described in detail below with reference to FIG. 6. In this case, especially, processing for calculating calibration values required to calibrate the rotation angles of the galvanometer mirrors 204 and 205 will be explained. As shown in FIG. 6, on the target member 105, cylindrical mirrors 601 each having a concave surface are configured on regions irradiated with light reflected by the galvanometer mirrors 204 and 205. However, each cylindrical mirror 601 need only be configured to change the light amount detected by the detector 206, and may be that of a convex surface. The cylindrical mirrors 601 are laid out in a two-dimensional pattern, and axes of the cylindrical mirrors 601 are directed in a plurality of directions including the x and y directions. Also, the position (coordinates) of the center of curvature of each cylindrical lens 601 has been precisely calibrated using a contact type three-dimensional coordinate measuring machine (CMM). Thus, the region of reflection surface of the cylindrical mirror 601 on the target member 105 is positioned to the measurement head 104 in a predetermined position (measurement position). In other words, the reflection surface of the cylindrical mirror 601 is positioned to the galvanometer mirror (scanning member) 204.

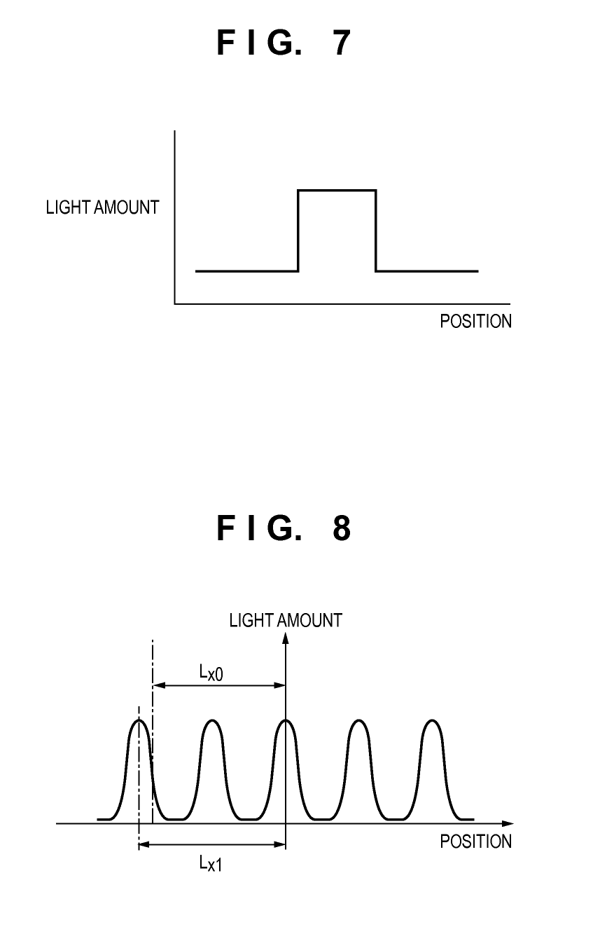

Initially, the position of the target member 105 arranged on the surface plate 101 is measured, and the measurement head 104 is moved to the measurement position. More specifically, the measurement head 104 is moved to a position immediately above each plane mirror 603 formed on the target member 105, perpendicularly irradiates that plane mirror 603 with light, and detects light reflected by the plane mirror 603, thereby calculating a distance from the measurement head 104 to the plane mirror 603. In this case, a distance between each of three or more plane mirrors 603 formed on the target member 105 and the measurement head 104 is calculated, and a position and tilt (θx, θy) of the target member 105 in the z direction are measured. Then, the measurement head 104 is moved to a position immediately above each of an X alignment mark 604 and Y alignment mark 605 formed on the target member 105. In this embodiment, the X alignment mark 604 and Y alignment mark 605 are configured by steps, but they may be configured by reflection films or the like. For example, when the X alignment mark 604 used in alignment of the x-axis direction is irradiated with light, a light amount (length measured value) of light reflected by the X alignment mark 604 changes according to the position on the target member 105 in the x-axis direction, as shown in FIG. 7. Referring to FIG. 7, the position of the X alignment mark 604 can be specified from a position where a light amount of light reflected by the X alignment mark 604 changes largely. In FIG. 7, the abscissa plots the position on the target member 105 in the x-axis direction, and the ordinate plots the light amount of light reflected by the X alignment mark 604. In this manner, using the X alignment mark 604 and Y alignment mark 605, the position (that on an x-y plane) on the target member 105 is measured. Then, based on the position on the target member 105, the measurement head 104 is moved to the measurement position. In this embodiment, the central position on the target member 105 in the x- and y-axis directions, and the position separated from the target member 105 by a distance WD in the z-axis direction correspond to the measurement position of the measurement head 104. In this case, a distance from the target member 105 to the measurement head 104, more specifically, that to the galvanometer mirror 204 is uniquely determined.

After the measurement head 104 is moved to the measurement position, the galvanometer mirror 205 is rotated so that a reference position (a position of the center of curvature) of each cylindrical mirror 601 of the target member 105 is irradiated with light. Then, in this state, a (change in) light amount of light reflected by the cylindrical mirror 601 is detected by the detector 206. FIG. 8 shows an example of the light amount of light which is reflected by the cylindrical mirror 601 and is detected by the detector 206. In FIG. 8, the abscissa plots the position on the target member 105 in the x-axis direction, and the ordinate plots the light amount of light reflected by the cylindrical mirror 601. Referring to FIG. 8, the light amount is maximized (a maximum light amount) at the position of the center of curvature of the cylindrical mirror 601. Letting Lₓ₁ be a distance from that position (x coordinate) corresponding to the maximum light amount to the position of a reflection point of the galvanometer mirror 205 in the x-axis direction, a rotation angle θₓ₁ of the galvanometer mirror 205 is expressed by:

$${θ}_{x 1} = \frac{1}{2} arctan ( \frac{{L}_{x 1} cos {θ}_{x}}{WD + {L}_{x 1} sin {θ}_{x}} ) \qquad ( 9 )$$

Also, letting Lₓ₀ be a reference distance from the position of the center of curvature of the cylindrical mirror 601 in the x-axis direction to the position of a reflection point of the galvanometer mirror 205 in the x-axis direction, a reference angle θₓ₀ of the galvanometer mirror 205 is expressed by:

$${θ}_{x 0} = \frac{1}{2} arctan ( \frac{{L}_{x 0} cos {θ}_{x}}{WD + {L}_{x 0} sin {θ}_{x}} ) \qquad ( 10 )$$

Note that the position of the center of curvature of the cylindrical mirror 601 in the x-axis direction has been obtained in the aforementioned calibration using the CMM.

A difference Δθₓ (=θₓ₁−θₓ₀) between the reference angle θₓ₀ and rotation angle θₓ₁ is used as a calibration value (correction value) of the rotation angle of the galvanometer mirror 205. This calibration value is calculated for all the cylindrical mirrors 601 formed on the target member 105, thereby precisely calibrating the rotation angle of the galvanometer mirror 205 on a two-dimensional region irradiated with light reflected by the galvanometer mirror 205. More specifically, the calibration values are held in a memory of the processing unit 106, and the rotation angle of the galvanometer mirror 205 is calibrated for each scanning angle, thereby precisely controlling the actual irradiation position of light reflected by the galvanometer mirror 205.

As described above, as processing for calculating the calibration value required to calibrate the rotation angle of the galvanometer mirror 205, the following three processes (first, second, and third processes) need only be executed. In the first process, in a state in which the galvanometer mirror 205 is rotated so as to irradiate the reference position of each cylindrical mirror 601 on the target member 105 with light, the light amount of light reflected by the cylindrical mirror 601 is detected by the detector 206. In the second process, an actual irradiation position actually irradiated with light with respect to the cylindrical mirror 601 in the first process is calculated based on the light amount detected by the detector 206. In the third process, a calibration value required to calibrate the rotation angle of the galvanometer mirror 205 is calculated from a difference between the actual irradiation position calculated in the second process and the reference position of the cylindrical mirror 601.

In this embodiment, since the cylindrical mirrors 601 are formed in a two-dimensional pattern, a deviation of the rotation angle generated as a combination of an error in the x-axis direction and that in the y-axis direction can also be detected. In other words, since the cylindrical mirrors 601 are formed in a two-dimensional pattern, the rotation angle of the galvanometer mirror 205 can be calibrated more precisely than a case in which the cylindrical mirrors 601 are formed in a one-dimensional pattern.

According to the measurement apparatus 1 of this embodiment, a deviation of the rotation angle of the galvanometer mirror 205 can be precisely calibrated, and a position of light (that reflected by the galvanometer mirror 205) projected from the measurement head 104 onto the object MT can be precisely controlled. Therefore, the measurement apparatus 1 can precisely measure the shape of the object MT.

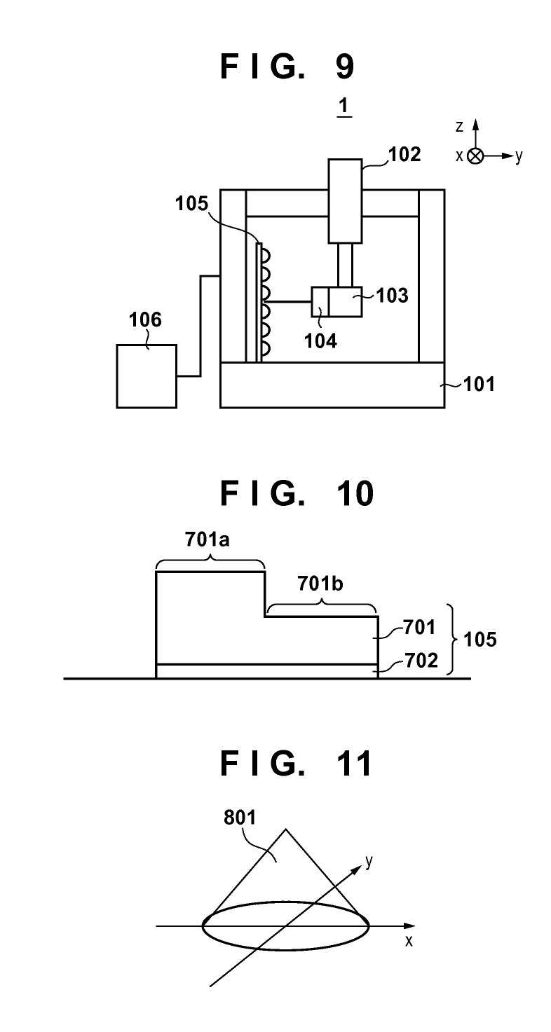

Also, a case will be examined wherein the measurement head 104 is rotated through 90° by the rotation stage 103, as shown in FIG. 9. In this case, since the rotation stage 103, measurement head 104, and galvanometer mirrors 204 and 205 are set in a state different from that shown in FIG. 6 due to deformations caused by self weights, the galvanometer mirrors 204 and 205 suffer different deviations of the rotation angles from the state shown in FIG. 6. Therefore, the target member 105 is required to be laid out parallel to an x-z plane, as shown in FIG. 9, so as to calibrate the rotation angles of the galvanometer mirrors 204 and 205. Note that as for calibration of the rotation angles of the galvanometer mirrors 204 and 205, the z-axis direction shown in FIG. 6 is replaced by the y-axis direction shown in FIG. 9, and the x-y plane shown in FIG. 6 is replaced by the x-z plane shown in FIG. 9. Hence, a detailed description thereof will not be repeated.

On the target member 105, a phase shift element 701 and plane mirror 702 may be configured on a region irradiated with light reflected by the galvanometer mirrors 204 and 205, as shown in FIG. 10. The phase shift element 701 generates a λ/4 phase difference by the (step having the) optical path length difference between left and right regions 701a and 701b. Therefore, light projected onto the target member 105 is transmitted through the phase shift element 701 and is reflected by the plane mirror 702, thus generating a λ/2 phase difference between the regions 701a and 701b of the phase shift element 701.

When light is scanned on the phase shift element 701, when it reaches a central position (a boundary between the regions 701a and 701b) of the phase shift element 701, a light amount detected by the detector 206 becomes zero. This is because light amounts cancel with each other by light which has passed through the region 701a of the phase shift element 701 and that which has passed through the region 701b of the phase shift element 701. Therefore, the target member 105 on which the phase shift element 701 and plane mirror 702 are configured as shown in FIG. 10 can obtain doubled sensitivity compared to the related art.

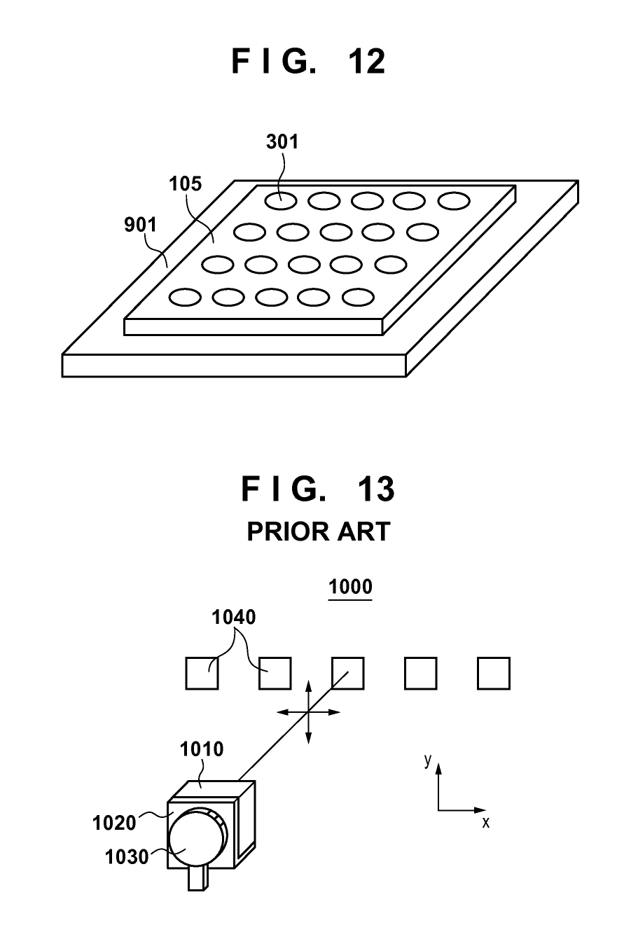

On the target member 105, a mirror element 801 having a conical shape of a convex surface may be configured on a region irradiated with light reflected by the galvanometer mirrors 204 and 205, as shown in FIG. 11. When light is scanned along the x axis on the target member 105, a reflection angle of light largely changes depending on the positive and negative sides of the x axis with respect to the center of the mirror element 801. Therefore, the mirror element 801 can improve sensitivity to deviations of the rotation angles of the galvanometer mirrors 204 and 205 compared to the related art as in the mirror element 301 having a curvature of a convex surface. Note that the mirror element 801 need only be configured to change the light amount detected by the detector 206 according to a light irradiation position, and it may have a conical shape of a concave surface or a pyramidal shape of a concave or convex surface.

Also, on the target member 105, a reflection member having a reflectance distribution may be configured on the region irradiated with light reflected by the galvanometer mirrors 204 and 205. For example, by setting a reflectance near the center of the reflection member higher than that of a peripheral portion, the light amount detected by the detector 206 can change according to the light irradiation position. Therefore, the reflection member having the reflectance distribution can improve sensitivity to deviations of the rotation angles of the galvanometer mirrors 204 and 205 compared to the related art as in the mirror element 301 having a curvature of a convex surface.

Furthermore, using a micromotion stage 901 which moves while holding the target member 105, as shown in FIG. 12, a calibration value required to calibrate the rotation angle of the galvanometer mirror can be calculated precisely (at a high resolution).

More specifically, the target member 105 held by the micromotion stage 901 is laid out parallel to the x-y plane, and the rotation angle of the galvanometer mirror is calibrated, as described above.

Next, the micromotion stage 901 is moved by a small amount ΔL in the x-axis direction. A reference angle θ′ₓ₀ of the galvanometer mirror in this state is expressed by:

$${θ}_{x 0}^{′} = \frac{1}{2} arctan ( \frac{( {L}_{x 0} + Δ L ) cos {θ}_{x}}{WD + ( {L}_{x 0} + Δ L ) sin {θ}_{x}} ) \qquad ( 11 )$$

Therefore, since a small difference is generated in the angle of the galvanometer mirror in the x-axis direction before and after movement of the micromotion stage 901, a calibration value required to calibrate the rotation angle of the galvanometer mirror can be calculated as an angle at a finer interval. In other words, processing for moving the micromotion stage 901 which holds the target member 105 and that for detecting a light amount of light reflected by the mirror element 301 of the target member 105 by the detector 206 are alternately repeated a plurality of times, thus calculating calibration values more precisely. Likewise, by moving the micromotion stage 901 by a small amount in the y-axis direction, the rotation angle of the galvanometer mirror in the y-axis direction can be calculated as an angle at a finer interval.

The above embodiment has explained the case using the galvanometer mirror as a scanning member of an optical apparatus. As the scanning member, a member having a function of deflecting a light beam can be used, and a polygonal mirror or prism may be used in place of the galvanometer mirror. Also, a light beam may be deflected (scanned) using an acoustooptic element (AOM). A piezoelectric element may be used as an AOM element, and ultrasonic waves (high-frequency waves) may be applied to change a frequency, thereby scanning a light beam.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2012-229243 filed on Oct. 16, 2012, and 2013-191036 filed on Sep. 13, 2013, which are hereby incorporated by reference herein in their entirety.

What is claimed is:

1. A calibration apparatus for calibrating an optical apparatus, which has a scanning member and scans light on an object by rotating the scanning member, comprising:
a target member including a region irradiated with light from the scanning member;
an obtaining unit configured to obtain a light amount of light reflected by the region; and
a processing unit configured to execute processing for calculating a calibration value required to calibrate a rotation angle of the scanning member,
wherein the region is configured to be nonplanar so that a light amount obtained by the obtaining unit changes according to a light irradiation position, and
the processing unit executes:
a first process for obtaining a light amount of light reflected by the region by the obtaining unit in a state in which the scanning member is rotated so as to irradiate a reference position of the region with light;
a second process for calculating an actual irradiation position where the region is actually irradiated with light in the first process based on the light amount obtained in the first process; and
a third process for calculating the calibration value from the actual irradiation position calculated in the second process and the reference position of the region.

2. The apparatus according to claim 1, wherein the region is configured by a mirror having a concave surface or a convex surface.

3. The apparatus according to claim 1, wherein the region is configured by a cylindrical mirror of a concave surface or a convex surface.

4. The apparatus according to claim 2, wherein the obtaining unit includes a detection unit having a detection surface configured to detect a light reflected by the region,
letting (x, y) be position coordinates on the detection surface, d be a deviation amount between a center of the detection surface and an incident position of light reflected by the region on the detection surface, a be a radius of light which is reflected by the region and enters the detection surface, and J₁( ) be a Bessel function of the first kind,
an ideal light amount I(d, a) obtained by the obtaining unit when the region is irradiated with light is expressed by:
$$I ( d , a ) = {\int }_{- a}^{a} {\int }_{- a}^{a} {( \frac{2 {J}_{1} ( \sqrt{{x}^{2} + {( y - d )}^{2}} )}{\sqrt{{x}^{2} + {( y - d )}^{2}}} )}^{2} d x d y$$
the calibration value of the region which is irradiated with light is calculated from the ideal light amount I(d, a).

5. The apparatus according to claim 1, wherein the region is configured by an element including a step having an optical path length difference which generates a λ/4 phase difference of light to be reflected.

6. The apparatus according to claim 1, wherein the region is configured by a mirror having a conical shape of a concave surface or a convex surface.

7. The apparatus according to claim 1, wherein a plurality of the regions are laid out on the target member in a two-dimensional pattern.

8. The apparatus according to claim 1, further comprising a stage which moves while holding the target member,
wherein the processing unit alternately repeats movement of the stage and the first process a plurality of times.

9. The apparatus according to claim 1, wherein the optical apparatus is a measurement apparatus which comprises a measurement head including the scanning member and a detection unit configured to detect light reflected by the object, and measures a shape of the object.

10. A calibration apparatus for calibrating an optical apparatus, which has a scanning member and scans light on an object by rotating the scanning member, comprising:
a target member including a region irradiated with light from the scanning member;
an obtaining unit configured to obtain a light amount of light reflected by the region; and
a processing unit configured to execute processing for calculating a calibration value required to calibrate a rotation angle of the scanning member,
wherein the region is configured by a reflection member having a reflectance distribution with which a light amount obtained by the obtaining unit changes according to a light irradiation position, and
the processing unit executes:
a first process for obtaining a light amount of light reflected by the region by the obtaining unit in a state in which the scanning member is rotated so as to irradiate a reference position of the region with light;
a second process for calculating an actual irradiation position where the region is actually irradiated with light in the first process based on the light amount obtained in the first process; and
a third process for calculating the calibration value from the actual irradiation position calculated in the second process and the reference position of the region.

11. The apparatus according to claim 10, wherein the optical apparatus is a measurement apparatus which comprises a measurement head including the scanning member and a detection unit configured to detect light reflected by the object, and measures a shape of the object.

12. A calibration method for calibrating an optical apparatus, which has a scanning member and scans light on an object by rotating the scanning member, using a target member including a region irradiated with light from the scanning member, the method comprising:
a first step of detecting a light amount of light reflected by the region in a state in which the scanning member is rotated so as to irradiate a reference position of the region with light;
a second step of calculating an actual irradiation position where the region is actually irradiated with light in the first step based on the light amount detected in the first step; and
a third step of calculating a calibration value required to calibrate a rotation angle of the scanning member from the actual irradiation position calculated in the second step and the reference position of the region,
wherein the region is configured to be nonplanar so that a light amount to be detected changes according to a light irradiation position.

13. A measurement apparatus for measuring a shape of an object, comprising:
a scanning member;
a scanning unit configured to scan light on the object by rotating the scanning member;
a target member including a region irradiated with light from the scanning member;
a detection unit configured to detect light reflected by the object and light reflected by the region;
a calculation unit configured to calculate the shape of the object based on the light which is reflected by the object and is detected by the detection unit; and
a processing unit configured to execute processing for calculating a calibration value required to calibrate a rotation angle of the scanning member,
wherein the region is configured to be nonplanar so that a light amount detected by the detection unit changes according to a light irradiation position, and
the processing unit executes:
a first process for detecting a light amount of light reflected by the region by the detection unit in a state in which the scanning member is rotated so as to irradiate a reference position of the region with light;
a second process for calculating an actual irradiation position where the region is actually irradiated with light in the first process based on the light amount detected in the first process; and
a third process for calculating the calibration value from the actual irradiation position calculated in the second process and the reference position of the region.
